(19) United States
(12) Patent Application Publication
(10) Pub. No.: US 2017/0305239 A1
(43) Pub. Date: Oct. 26, 2017

(54) AIR CONDITIONER VENT OUTLET PORTION STRUCTURE OF AUTOMOBILE

(71) Applicant: Honda Motor Co.,Ltd., Tokyo (JP)

(72) Inventors: Tadashi YODA, Saitama (JP); Hiroki SHIGEHARA, Saitama (JP); Tomohiko NARA, Tochigi (JP)

(73) Assignee: Honda Motor Co.,Ltd., Tokyo (JP)

(21) Appl. No.: 15/488,530

(22) Filed: Apr. 17, 2017

(30) Foreign Application Priority Data
Apr. 21, 2016 (JP) 2016-085192

(51) Int. Cl. B60H 1/34

(52) U.S. Cl. CPC B60H 1/3421; B60H 1/34

(57) ABSTRACT

An air conditioner vent outlet portion includes: an air conditioner vent outlet component, installed at a setting wall component in front of front seats in an automobile compartment, and having a vent outlet (11) of an air-conditioned air with an opening facing the interior of the automobile compartment; and a glossiness decorative component (13), installed at a peripheral edge portion of the vent outlet (11). Bumps (16) extending along a front-rear direction of the automobile are formed on the surfaces which face the interior of the automobile compartment, of the decorative component (13).

### CROSS-REFERENCE TO RELATED APPLICATION

This application claims the priority benefit of Japan application serial no. 2016-085192, filed on Apr. 21, 2016. The entirety of the above-mentioned patent application is hereby incorporated by reference herein and made a part of this specification.

### BACKGROUND OF THE DISCLOSURE

### 1. Field of the Disclosure

The disclosure generally relates to an air conditioner vent outlet portion structure of an automobile.

### 2. Description of Related Art

Air conditioner vent outlet portions of an air conditioning apparatus are arranged in an instrument panel in front of front seats of an automobile. The air conditioner vent outlet portion includes a box-shaped air conditioner vent outlet component having a vent outlet of air-conditioned air on a front surface facing the interior of the automobile compartment; and a frame-shaped decorative component (bezel) installed at a peripheral edge portion of the vent outlet of the air conditioner vent outlet component (e.g. referring to Japanese Laid-Open Patent Publication No. 2011-105035).

### SUMMARY OF THE DISCLOSURE

### Problems to be Solved by the Disclosure

With respect to the air conditioner vent outlet portion described in the Japanese Laid-Open Patent Publication No. 2011-105035, in a case where the decorative component installed at the air conditioner vent outlet component is performed a plating process with an ornament with high glossiness, the surface of the decorative component may reflect extraneous light, and sometimes the extraneous light may enter a side mirror area of a side window of the automobile and further enters the field of vision of a passenger, thereby discomforting the passenger.

Therefore, the disclosure is directed to an air conditioner vent outlet portion structure of an automobile as follows, and the air conditioner vent outlet portion structure of the automobile is not prone to reflecting the incident extraneous light, which enters the decorative component, towards the side window direction, thereby improving the comfort of the passenger.

### Technical Means for Solving the Problems

In order to solve the foregoing problems, an air conditioner vent outlet portion structure of an automobile of the disclosure adopts the following structure.

That is, the air conditioner vent outlet portion structure of the automobile of the disclosure is characterized by including: an air conditioner vent outlet component (for example, a register case 12 of embodiments), installed at a setting wall component in front of front seats in an automobile compartment (for example, an instrument panel 2 of the embodiments), and having a vent outlet of an air-conditioned air with an opening facing the interior of the automobile compartment (for example, the vent outlet 11 of the embodiments); and a decorative component (for example, the decorative component 13 of the embodiments), having a glossiness and installed at the peripheral edge portion of the vent outlet of the air conditioner vent outlet component, and provided with a plurality of bumps extending along the front-rear direction of the automobile (for example, the bumps 16 of the embodiments) on the surfaces of the decorative component facing the interior of the automobile compartment.

According to the structure, if extraneous light is incident to the portion which has a plurality of bumps, of the surface of the decorative component, the extraneous light will be scattered in multiple directions, thereby preventing the situation that the extraneous light is intensively reflected in one direction. Therefore, even if the light incident onto the surface of the decorative component is reflected onto the side window, the passenger does not feel dazzling. Furthermore, the bumps formed on the surface of the decorative component extend along the front-rear direction of the automobile, so that the light can be effectively enforcedly scattered, and the extraneous light coming over the front portion of the automobile is not concentrated towards the side window direction.

The plurality of bumps can also be disposed on one surface, which faces only one direction, among the surfaces, which face the interior of the automobile compartment, of the decorative component.

In this case, since the plurality of bumps is only disposed on the surface facing one direction of the decorative component, the plurality of bumps can be easily formed on the surface of the decorative component when the decorative component is molded. That is, as long as a forming portion for the bumps is formed in a mold in advance, in the molding process of the decorative component for forming the decorative component, the plurality of bumps can be simultaneously formed on the surface of the decorative component; and moreover, since the plurality of bumps are only formed on the surface facing one direction of the decorative component, no complicated forming mold is used, and the mold releasing process can also be easily done. Accordingly, by adopting the structure described above, the forming mold and forming procedures for forming the decorative component can be simplified.

The plurality of bumps can also be only disposed on the upper surface which faces an upward of the automobile), among the surfaces facing the interior of the automobile compartment, of the decorative component (for example, the upper surface 13b-p of the embodiments).

In this case, when the decorative component is molded, a plurality of bumps can be easily disposed on the surface of the decorative component, and the reflection of the extraneous light reflected by the upper surface, on which the extraneous light is most easily incident from the upward of the front portion of the automobile, of the decorative component can be effectively reduced.

### Effects of the Disclosure

According to the disclosure, since a plurality of bumps extending along the front-rear direction of the automobile is formed on the surface, which faces the interior of the automobile compartment, of the decorative component, the extraneous light which is incident to the decorative component can be effectively prevented from being reflected towards the side window direction. Therefore, in the case of adopting the disclosure, the extraneous light reflected by the decorative component can be inhibited from entering the side window, thereby improving the comfort of the passenger.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a perspective view showing an interior of an automobile compartment of an automobile according to one embodiment of the disclosure.

FIG. 2 is a perspective view showing an interior of an automobile compartment of the automobile according to one embodiment of the disclosure.

FIG. 3 is a perspective view showing an air conditioner vent outlet portion of the automobile according to one embodiment of the disclosure.

FIG. 4 is a perspective view showing another air conditioner vent outlet portion of the automobile according to one embodiment of the disclosure.

### DESCRIPTION OF THE EMBODIMENTS

Embodiments of the disclosure are described below with reference to the accompanying drawings. In the following description, directions such as front, rear, left, and right directions are the same as those of the automobile, unless otherwise specified. In addition, the arrow FR indicating the front direction of the automobile, the arrow LH indicating the left direction of the automobile, and the arrow UP indicating the upper side of the automobile are marked on appropriate positions in the drawings used in the following description.

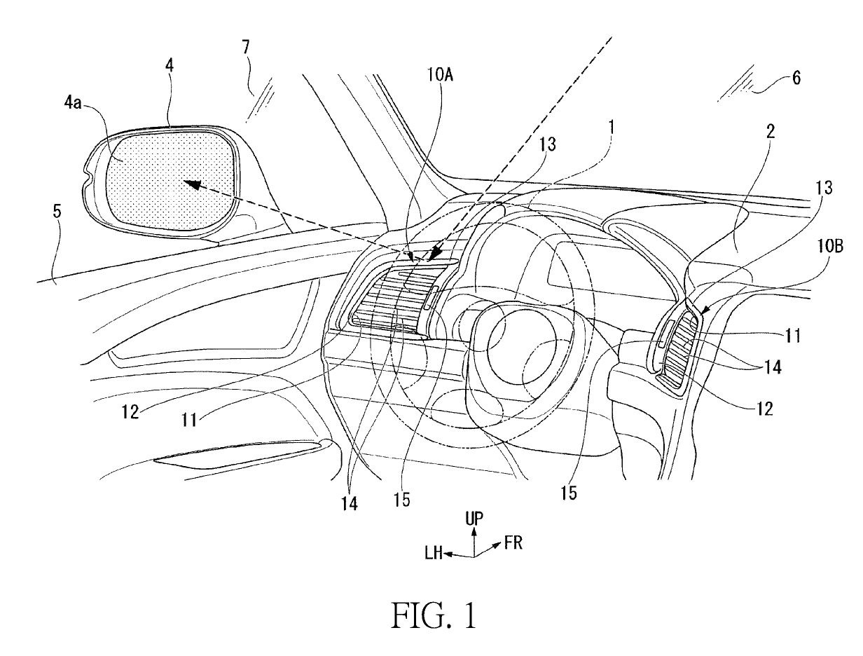

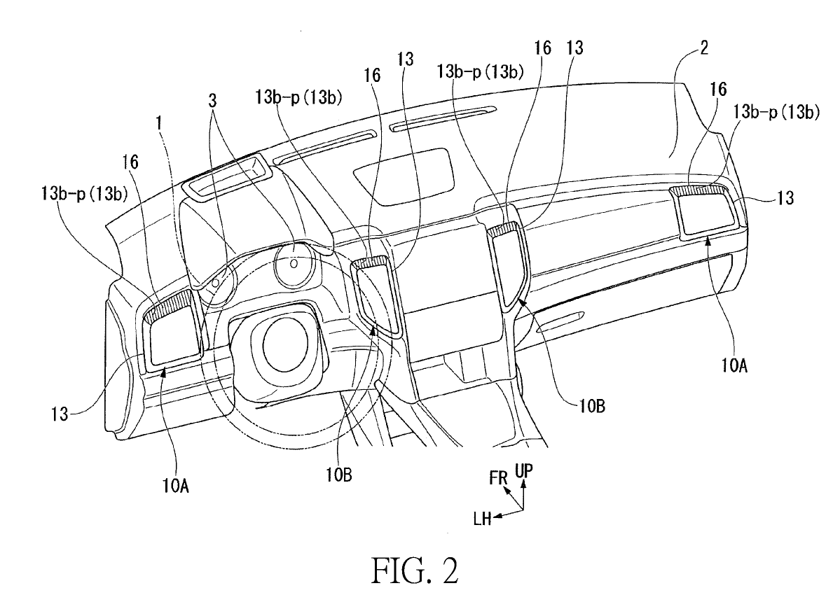

FIG. 1 is a front view of a left front seat in an automobile compartment viewed from an upper side of a right rear portion, and FIG. 2 is a front view of front seats in the automobile compartment viewed from the upper side of a left rear portion. The automobile in the present embodiment is a left hand drive automobile with a driver seat disposed at the left side, and a steering wheel 1 is arranged at the left front side in the automobile compartment. As shown in FIG. 1 and FIG. 2, the reference numeral 2 indicates an instrument panel (setting wall component) arranged in front of the front seats in the compartment of the automobile and provided with various instruments 3 (referring to FIG. 2) or air conditioner vent outlet portions 10A and 10B of an air conditioning apparatus. In addition, the reference numeral 4 indicates a side mirror arranged at a front side door 5, and the reference numeral 6 indicates wind shield glass arranged over the front portion of the instrument panel 2. A side window 7 is installed at the side door 5 in a free lifting manner.

The air conditioner vent outlet portion 10A is arranged in an outer side area (not shown) in the automobile width direction in front of the front seats, and the air conditioner vent outlet portion 10B is arranged in an inner side area (not shown) in the automobile width direction in front of the front seats.

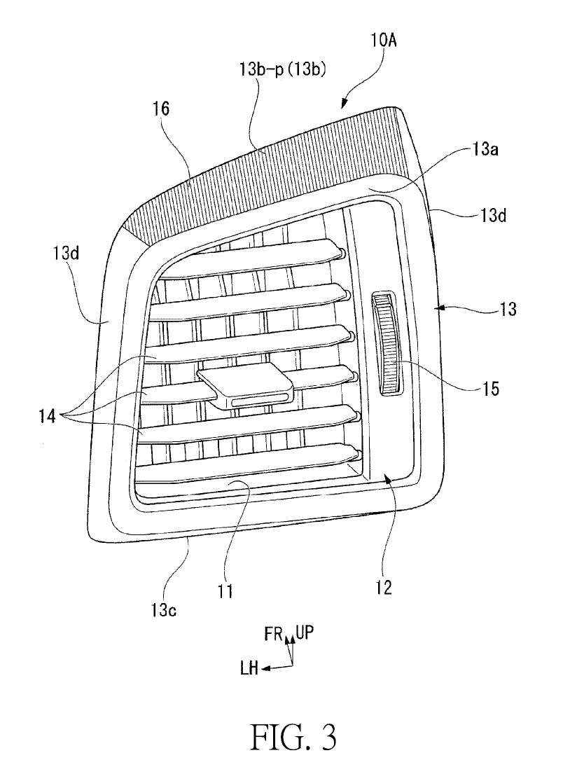

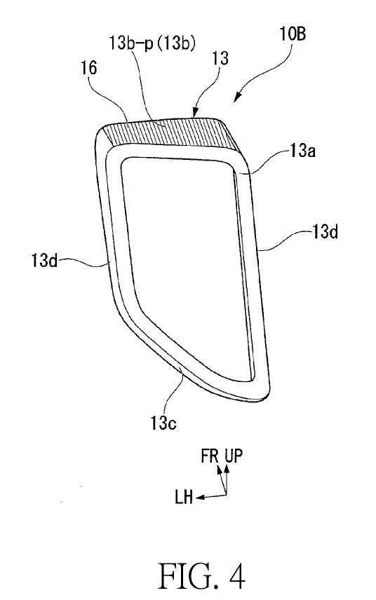

FIG. 3 is a diagram showing the air conditioner vent outlet portion 10A arranged in the outer side area in the automobile width direction, and FIG. 4 is a diagram showing one portion of the air conditioner vent outlet portion 10B arranged in the inner side area in the automobile width direction. The air conditioner vent outlet portions 10A and 10B are slightly different in size or shape, but generally identical in basic structures. The structure will be described below in detail focusing on the air conditioner vent outlet portion 10A in the outer side area in the automobile width direction shown in FIG. 3.

As shown in FIG. 3, the air conditioner vent outlet portion 10A is installed at a longitudinal wall of the instrument panel 2 opposite to the front seats and includes a box-shaped register case 12 (air conditioner vent outlet component) having a vent outlet of air-conditioned air 11 with an opening facing the interior of the automobile compartment; and a decorative component 13 installed at the register case 12 in a manner of covering a peripheral edge portion of the vent outlet 11 of the register case 12. The register case 12 is formed by a resin material, and the surface of the register case 12 is provided with a black coating having glossiness. The decorative component 13 is formed by a resin material, and the surface of the decorative component 13 is (having glossiness) performed a plating treatment in a metal style.

The vent outlet 11 of the register case 12 is formed in a substantially square shape in a front view. The internal of the vent outlet 11 of the register case 12 is provided with a plurality of fins 14 for changing a wind direction, a side edge portion of the vent outlet 11 is provided with an air volume adjusting dial 15, and the air volume adjusting dial 15 is used for operating an air volume adjustment damper (not shown) in the register case 12.

The decorative component 13 is formed in a rectangular frame shape in the front view in a manner of surrounding the vent outlet 11 of the register case 12. The decorative component 13 includes a rectangular frame-shaped front wall 13a, pointing to the rear side of an automobile body; an upper wall 13b connected with the upper end of an upper edge of the front wall 13a; a lower wall 13c connected with the lower end of a lower edge of the front wall 13a; and a left and right side walls 13d connected with the outer side ends of a left side edge and a right side edge of the front wall 13a. The upper wall 13b, the left and right side walls 13d and the lower wall 13c are connected to form a ring shape protruding towards the inner side of the automobile compartment relative to the front surface of the instrument panel 2.

Particularly in the case of the present embodiment, since the upper portion of the front surface of the instrument panel 2 is provided with a bending portion bent towards the front side of the automobile body, and the protruding width of the upper wall 13b of the decorative component 13 relative to the front surface of the instrument panel 2 is greater than other portions. In addition, in the case of the present embodiment, the protruding width of the upper wall 13b of the decorative component 13 is gradually increased from the outer side to the inner side in the automobile width direction.

In the entire area of the upper surface 13b-p (the surface of the upper side) of the upper wall 13b of the decorative component 13, a plurality of bumps 16 extending along the front-rear direction of the automobile body is formed in stripe-shaped.

The decorative component 13 is formed through, for example, a molding process, and then the surface of the decorative component 13 can be performed a plating treatment in a metal style. A bump forming portion is pre-formed on the inner surface of a mold in advance, whereby a plurality of bumps 16 can be simultaneously formed on the upper surface 13b-p of the decorative component 13 when the decorative component is molded during the molding process.

In the case of adopting the air conditioner vent outlet portions 10A and 10B according to the present embodiment, if the extraneous light illuminates the upper surfaces 13b-p of the decorative components 13 of the air conditioner vent outlet portions 10A and 10B through the wind shield glass 6, the extraneous light can be scattered in multiple directions due to the plurality of bumps 16, extending along the front-rear direction of the automobile body, on the upper surface 13b-p. Therefore, the situation that the light reflected by the upper surface 13b-p of the decorative component 13 is concentrated in one direction is inhibited. Particularly, the plurality of bumps 16 formed on the upper surface 13b-p of the decorative component 13 extend along the front-rear direction of the automobile body, so that the reflected extraneous light can be effectively scattered rather than being concentrated to the side window 7 in the direction of a mirror face 4a of the side mirror 4.

To sum up, in the air conditioner vent outlet portions 10A and 10B of the present embodiment, the entire area of the upper surface 13b-p (the surface of the upper side) of the decorative component 13, which is performed the plating treatment in the metal style, is formed with a plurality of bumps 16 extending along the front-rear direction of the automobile. Therefore, the extraneous light incident onto the upper surface 13b-p of the decorative component 13 can be effectively prevented from being reflected to the side window 7 in the direction of the mirror face 4a of the side mirror 4 through the bumps 16.

Therefore, in the case of adopting the air conditioner vent outlet portions 10A and 10B of the present embodiment, the extraneous light reflected by the upper surface 13b-p of the decorative component 13 can be prevented from coming into the side window 7 at a high brightness. Thus, the visibility of the side mirror 4 for the passenger can be improved, and the comfort of the passenger can be improved.

Furthermore, in the air conditioner vent outlet portions 10A and 10B of the present embodiment, only the surface, facing one direction (the upper surface 13b-p), of the decorative component 13 is formed with the plurality of bumps 16 extending along the front-rear direction of the automobile. Therefore, in the case where the decorative component 13 is manufactured through a molding process, as long as the forming portion for the bumps 16 is pre-formed on one inner surface of the mold, no complicated forming mold needs to be used, and the mold releasing process can also be easily executed. Accordingly, by adopting the air conditioner vent outlet portions 10A and 10B, the forming mold and molding process for forming the decorative component 13 can be simplified.

The surface, formed with the plurality of bumps 16, of the decorative component 13 can be a surface other than the upper surface 13b-p. However, in the case where only the upper surface 13b-p of the decorative component 13 is provided with the plurality of bumps 16 as that in the present embodiment, the plurality of bumps 16 can be easily formed without using a complicated mold, and the reflection of extraneous light by the upper surface 13b-p, on which the extraneous light is mostly easily incident over the front portion of the automobile through the wind shield glass 6, of the decorative component 13 can be effectively reduced.

Moreover, the disclosure is not limited to the embodiment described above, and various design changes can be made without departing from the spirit scope of the disclosure. For example, in the present embodiment, the air conditioner vent outlet portions 10A and 10B are arranged at the instrument panel 2, but as long as the air conditioner vent outlet portions are arranged at the setting wall component in front of the front seats in the automobile compartment, the air conditioner vent outlet portions can also be arranged at a component other than the instrument panel 2.

Furthermore, the decorative component 13 with the surface plated in the metal style is used in the present embodiment, but the decorative component 13 is unnecessarily a plated component, and the component having glossiness on the surface may be a metal component or a coating.

What is claimed is:

1. An air conditioner vent outlet portion structure of an automobile, comprising:
an air conditioner vent outlet component, installed at a setting wall component in front of front seats in an automobile compartment, and having a vent outlet of an air-conditioned air with an opening facing an interior of the automobile compartment; and
a decorative component, having a glossiness, installed at a peripheral edge portion of the vent outlet of the air conditioner vent outlet component,
wherein a plurality of bumps extending along a front-rear direction of the automobile are formed on surfaces of the decorative component, and the surfaces face the interior of the automobile compartment.

2. The air conditioner vent outlet portion structure of the automobile according to claim 1, wherein the plurality of bumps are only disposed on one surface which faces one direction, among the surfaces facing the interior of the automobile compartment, of the decorative component.

3. The air conditioner vent outlet portion structure of an automobile according to claim 2, wherein the plurality of bumps are only formed at an upper surface which faces an upward of the automobile, among the surfaces facing the interior of the automobile compartment, of the decorative component.
